(19) United States
(12) Patent Application Publication
(10) Pub. No.: US 2006/0027346 A1
(43) Pub. Date: Feb. 9, 2006

(54) Horizontal fireproof rolling shutter without a lower rail

(76) Inventor: Chung Hsien Hsieh, Taipei Hsien (TW)

Correspondence Address: BUCKNAM AND ARCHER, 1077 NORTHERN BOULEVARD, ROSLYN, NY, 11576, US

(21) Appl. No.: 11/098,087

(22) Filed: Apr. 4, 2005

(30) Foreign Application Priority Data
Jul. 13, 2004 (TW) 093210985

(51) Int. Cl. E06B 9/00

(52) U.S. Cl. 160/232

(57) ABSTRACT

A horizontal fireproof rolling shutter without a lower rail, including: an upper rail, which is comprised of an external frame, an internal frame, and a sliding track and disposed at the top of a door; a door panel, comprised of a plurality of vertical panels serially connected with each other and rolled around an axle, wherein at least one roller is disposed at the top of each panel and slidably hanging on the sliding track; and a power unit, disposed on a side of the upper rail and controlled for driving the axle to push out or roll up the door panel, wherein the external frame comprises a plurality of vertical sliding grooves, and the sliding track is fixed to the top of the sliding grooves by a plurality of melting members separately, such that the bottom of the door panel is dropped to the floor. Thus, if a fire occurs, the melting members will be melted by the high temperature so as to drop the sliding track and the door panel onto the floor by weight, whereby the gap formed between the bottom of the door panel and the floor due to thermal expansion is blocked to stop flames or smoke from escaping.

### BACKGROUND OF THE INVENTION

1. Field of the Invention

The present invention relates to a rolling shutter, and more specifically, to a horizontal fireproof rolling shutter without a lower rail having a plurality of melting members that will be melted by the high temperature of a fire so as to drop the connected sliding track and the door panel onto the floor by weight, whereby the gap formed between the bottom of the door panel and the floor due to thermal expansion is blocked.

2. Description of the Prior Art

Referring to FIGS. 1 and 2, a conventional horizontal fireproof rolling shutter 10 is illustrated, which comprises: an upper rail 20, disposed at the top of a door 11 and comprised of an external frame 21, an internal frame 22 and a sliding track 23; a door panel 30, comprised of a plurality of vertical panels 31 serially connected with each other and rolled around an axle 32, wherein at least one roller 33 is disposed at the top of each panel 31 and slidably hanging on the sliding track 23, and at least one roller 34 is disposed at the bottom of each panel 31; a lower rail 40, installed on the floor corresponding to the upper rail 20 for sustaining the bottom of the door panel 30 and guiding the roller 34 to slide; a power unit 50, disposed on a side of the upper rail 20 and controlled to drive the axle 32 to push out the door panel 30 to close the door or roll up the door panel 30 to open the door.

In the foregoing conventional horizontal fireproof rolling shutter 10, since the lower rail 40 is installed on the floor, it not only affects the appearance, but also causes the unevenness of the floor and the inconvenience of cleaning. It should be understood by those skilled in the art that on the present technology, although the means of omitting the lower rail can be adopted to solve the problems, such design cannot meet the requirements of the safety standard of a fireproof door. More specifically, according to the U.S. National Laboratory Safety Specification Testing Standard UL, the gap between a safety door and the floor should be within the safety range of ⅝ inch in any high-temperature environments in relation to the safety specification of a fireproof door. Therefore, if the conventional horizontal fireproof rolling shutter does not adopt the lower rail, it will not affect the basic functions of the rolling shutter. However, when a fire occurs, since the top of the door panel undergoes much higher gravity than the bottom of the door panel because the top of the door panel is hanging on the sliding track, the bottom of the door panel will be bent due to thermal expansion under a high temperature, and a gap allowing flames or smoke to escape will be formed between the bottom of the door panel and the floor, which thus cannot meet the UL safety standard of a fireproof door. Therefore, in order to meet the UL safety standard of a fireproof door, a lower rail is usually adopted in this industry to fix the bottom of the door panel within the lower rail, so that when a fire occurs, the bottom of the door panel will only be deformed due to thermal expansion but not bent up under a high temperature, whereby the requirements of the safety standard are still met.

### SUMMARY OF THE INVNEION

It is a primary objective of the present invention to provide a horizontal fireproof rolling shutter without a lower rail, which has a plurality of melting members that will be melted by the high temperature of a fire so as to drop the connected sliding track and the door panel onto the floor by weight, whereby the gap formed between the bottom of the door panel and the floor due to thermal expansion is blocked to stop flames or smoke from escaping.

To achieve the foregoing and other objectives, the horizontal fireproof rolling shutter without a lower rail in accordance with the present invention comprises: an upper rail, comprised of an external frame, an internal frame and a sliding track and disposed at the top of a door; a door panel, comprised of a plurality of vertical panels serially connected with each other and rolled around an axle, wherein at least one roller is disposed at the top of each panel and slidably hanging on the sliding track; and a power unit, disposed on a side of the upper rail and controlled to drive the axle to push out or roll up the door panel, wherein the external frame comprises a plurality of vertical sliding grooves, and the sliding track is fixed onto the top of the sliding grooves by a plurality of melting members, such that the bottom of the door panel is dropped to the floor.

According to the present invention, the melting members are formed by soldering a first ring member and a second ring member that consist of metal of a low melting point and both can be melted and separate under a high temperature, wherein the first ring member is fixed onto the external frame by a screw fixture, the second ring member hangs the sliding track at the top of a sliding groove of the external frame by a screw fixture, and a sleeve is installed in the sliding groove between the second ring member and the sliding track. Thus, when a fire occurs, the melting members will be melted by the high temperature of the fire so as to drop the sliding track and the door panel to the floor by weight, whereby the gap formed between the bottom of the door panel and the floor due to thermal expansion is blocked to stop flames or smoke from escaping.

### BRIEF DESCRIPTION OF THE DRAWINGS

FIG. 1 is a schematic view of a horizontal fireproof rolling shutter having a lower rail according to a prior art;

FIG. 2 is a cross-sectional view of Section 2-2 depicted in FIG. 1;

FIG. 3 is a sectional schematic view of the horizontal fireproof rolling shutter without a lower rail according to an embodiment of the present invention;

FIG. 4 is a cross-sectional view of Section 4-4 depicted in FIG. 3;

FIG. 5 shows a front view and a side view of a conventional melting member involved with the present invention in an unmelted condition;

FIG. 5a shows a front view and a side view of the melting member depicted in FIG. 5 in a melted condition;

FIG. 6 is a sectional enlarged view of the horizontal fireproof rolling shutter of the present invention, wherein the melting member is in an unmelted condition;

FIG. 6a is a cross-section view of FIG. 6;

FIG. 7 is a sectional enlarged view of the horizontal fireproof rolling shutter of the present invention, wherein the melting member is in a melted condition; and

FIG. 7a is a cross-section view of FIG. 7.

### DETAILED DESCRIPTION OF THE PREFERRED EMBODIMENTS

The technical characteristics of the present invention will become apparent in the detailed description hereinafter with reference to the accompanying drawings of an embodiment which serves as a preferred embodiment; however, this preferred embodiment is not intended to limit the scope of the present invention.

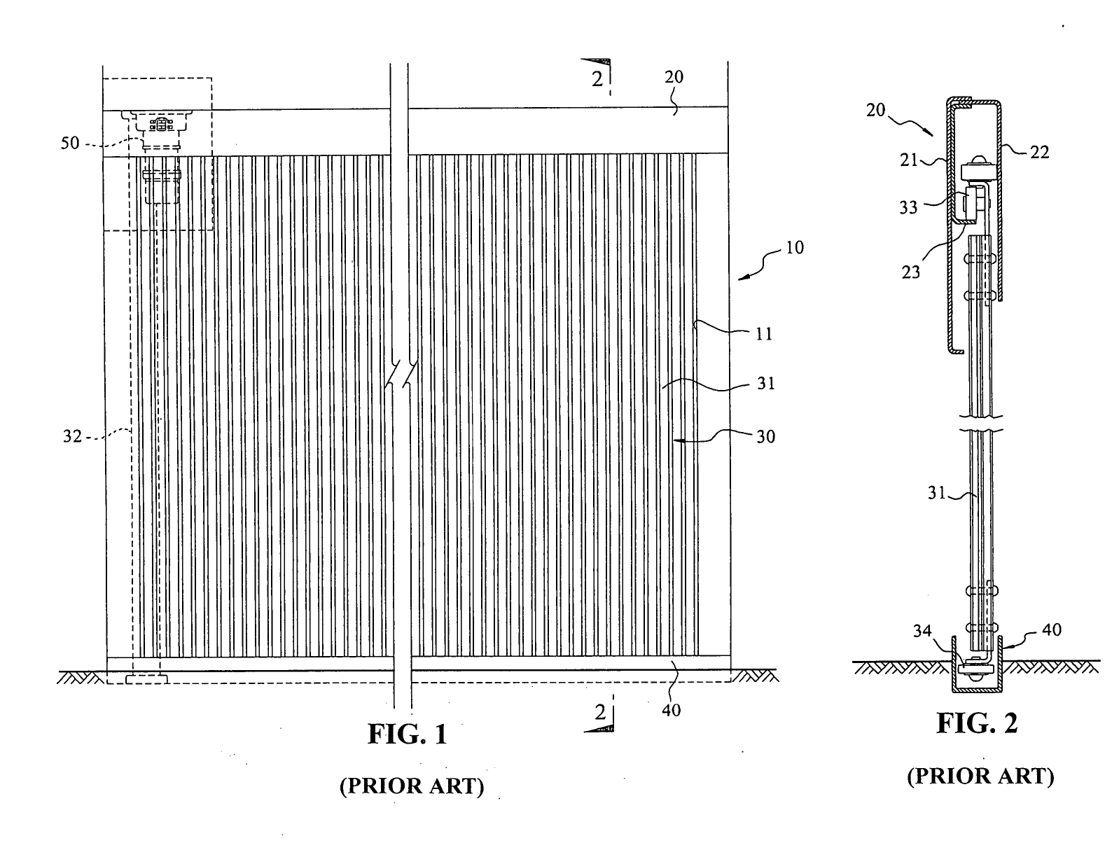

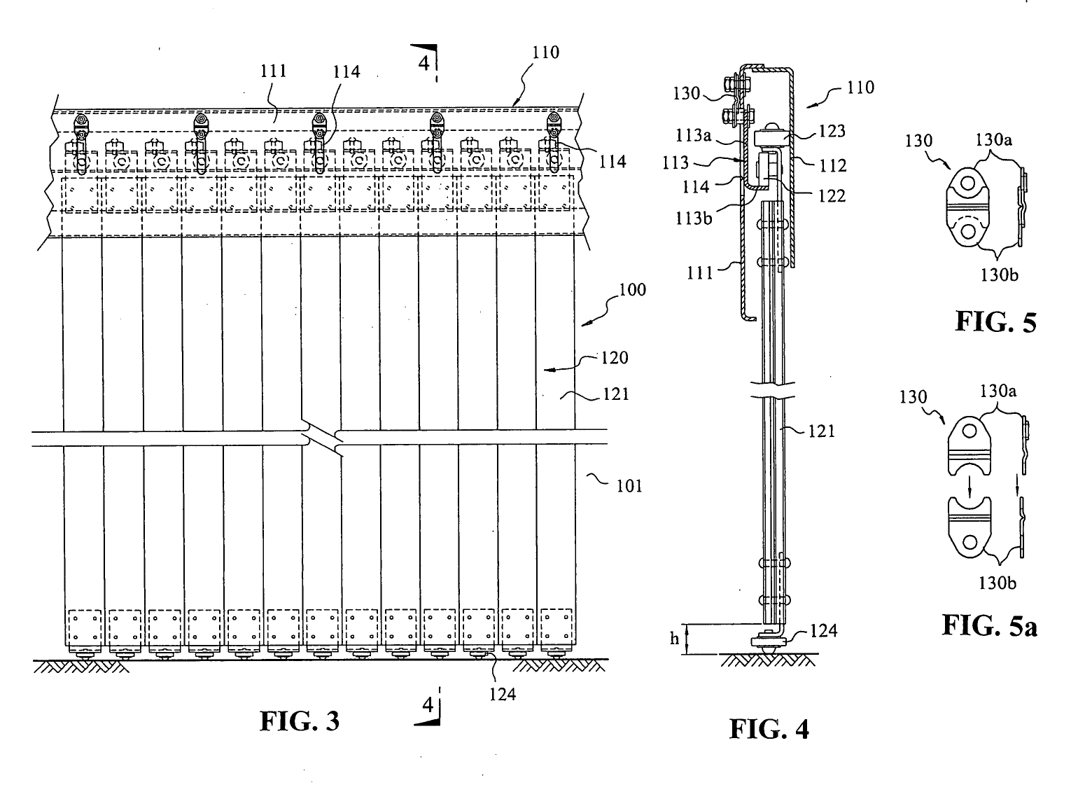

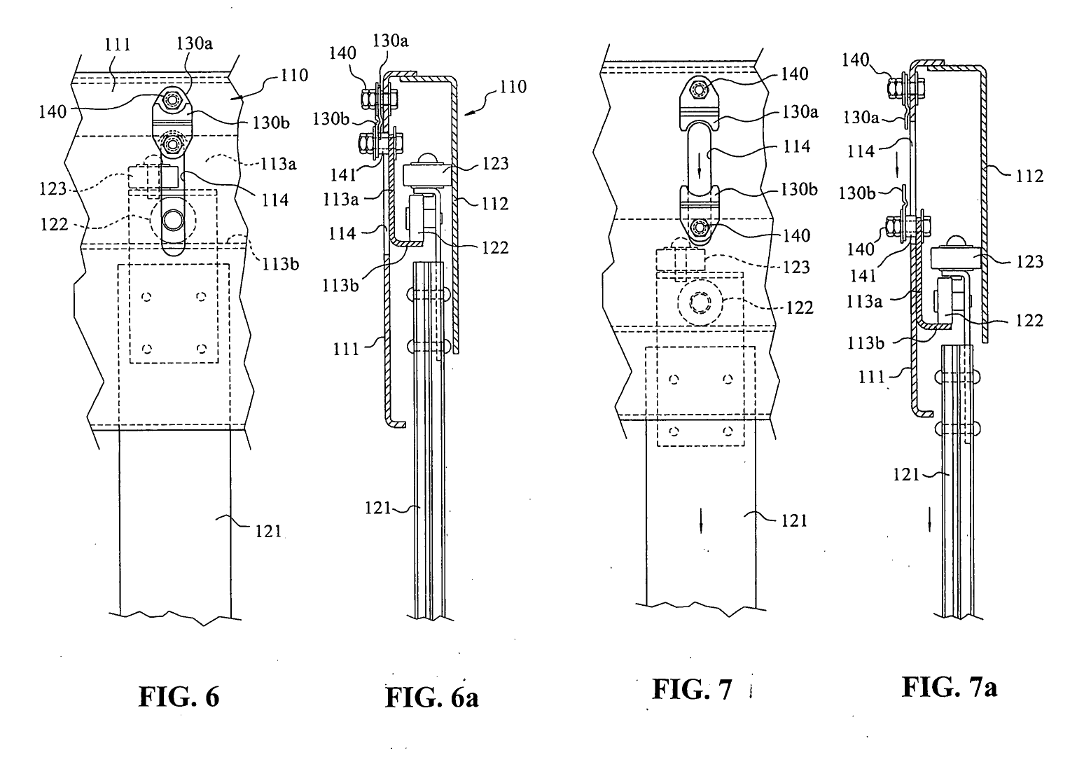

First, referring to FIGS. 3 and 4 together with FIGS. 6 and 6a, the horizontal fireproof rolling shutter without a lower rail 100 of the present invention has the same basic structure as the conventional horizontal rolling shutter shown in FIGS. 1 and 2, which comprises: an upper rail 110, disposed at the top of a door 101 and comprised of an external frame 111, an internal frame 112, and a sliding track 113, wherein the sliding track 113 comprises a vertical section 113a attached to the internal side of the external frame 111, and a horizontal section 113b disposed horizontally along the external frame 111; a door panel 120, comprised of a plurality of vertical panels 121 serially connected with each other and rolled around an axle (not shown in the figure) disposed on a side of the door, wherein a roller 122 is vertically disposed at the top of each panel 121 and slidably hanging on the horizontal section 113b of the sliding track 113, a roller 123 is horizontally disposed at the top of each panel 121 and capable of sliding against the internal frame 112, and further, a roller 124 is horizontally disposed at the bottom of each panel 121 to contact the floor; a power unit (not shown in the figure), disposed on a side of the upper rail 110 and controlled to drive the axle to push out the door panel 120 to close the door or roll up the door panel 120 to open the door. Unlike the prior art, the present invention comprises a plurality of vertical sliding grooves 114 equidistantly disposed on the external frame 111 of the upper rail 110, and the vertical section 113a of the sliding track 113 is hanging at the top of the sliding grooves 114 by a plurality of melting members 130 separately, such that the bottom of the door panel 120 is dropped to the floor, and the gap height h between the bottom of the door panel 120 and the floor is set lower than the UL safety standard of ⅝ inch.

FIGS. 5 and 5a are schematic views of a conventional melting member 130 involved with the present invention. FIG. 5 shows a front view and a side view of the melting member 130 in an unmelted condition, and FIG. 5a shows a front view and a side view of the melting member 130 in a melted condition. As shown in the figures, the melting member 130 is formed by soldering a first ring member 130a and a second ring member 130b that consist of metal of a low melting point and both can be melted and separate under a high temperature. Various melting points and loads are available at choice according to the specification.

Further, referring to FIGS. 6 and 6a together with FIGS. 7 and 7a, select a melting member 130 of an appropriate melting point and load according to the geographic location. The first ring member 130a is fixed onto the external frame 111 above the sliding groove 114 by a screw fixture 140, and the second ring member 130b hangs the sliding track 113 at the top of the sliding groove 114 by the screw fixture 140, wherein the screw fixture 140 is covered with a sleeve 141 between the second ring members 130b and the vertical section 113a of the sliding track 113, and the sleeve 141 is allowed to slide in the sliding groove 114. Therefore, if a fire occurs and cannot be put out by other safety measures, the melting member 130 will act as the last safeguard and will be melted by the high temperature of the fire, such that the first ring member 130a and the second ring member 130b will be separated. By then, the sliding track 113 and the door panel 120 will be separated and drop (as shown in FIGS. 7 and 7a) onto the floor by weight. Thus, even though the bottom of the door panel 120 is bent due to thermal expansion, the door panel 120 will touch the floor due to its weight and block the gap formed between the door panel 120 and the floor so as to stop flames or smoke from escaping.

To sum up, the horizontal fireproof rolling shutter without a lower rail according to the present invention is characterized in that its melting members can be melted by the high temperature of a fire so as to drop the door panel onto the floor, whereby the gap formed between the bottom of the door panel and the floor due to thermal expansion is blocked to stop flames or smoke from escaping. The present invention has a simple structure and is definitely novel, useful and complies with the requirements of a patent application.

The above description and its accompanying drawings are used for describing the preferred embodiment of the present invention. It is to be understood that the invention is not limited thereto, and it will be apparent to those skilled in the art that various changes and modification may be made without departing from the spirit and scope of the invention as defined in the following claims.

List of Reference Numerals

100: Horizontal Fireproof Rolling Shutter Without A Lower Rail Of The Present Invention
101: door
110: upper rail
111: external frame
112: internal frame
113: sliding track
113a: vertical section
113b: horizontal section
114: sliding groove
120: door panel
121: panel
122: roller
123: roller
124: roller
130: melting member
130a: first ring member
130b: second ring member
140: screw fixture
141: sleeve

What is claimed is:

1. A horizontal fireproof rolling shutter without a lower rail, comprising:
an upper rail, which is comprised of an external frame, an internal frame, and a sliding track and disposed at the top of a door;
a door panel, comprised of a plurality of vertical panels serially connected with each other and rolled around an axle disposed on a side of the door, wherein at least one roller is disposed at the top of each panel and slidably hanging on the sliding track; and
a power unit, disposed on a side of the upper rail and controlled for driving the axle to push out or roll up the door panel, characterized in that
the external frame comprises a plurality of vertical sliding grooves, and the sliding track is fixed to the top of the sliding grooves by a plurality of melting members separately, such that the bottom of the door panel is dropped to the floor.

2. The horizontal fireproof rolling shutter without a lower rail of claim 1, wherein each melting member comprises a first ring member and a second ring member coupled with each other, and the said first and second ring members can be melted and separate from each other by a high temperature.

3. The horizontal fireproof rolling shutter without a lower rail of claim 2, wherein each first ring member is fixed to the external frame by a screw fixture, and each second ring member is fixed to the sliding track by a screw fixture.

4. The horizontal fireproof rolling shutter without a lower rail of claim 3, wherein a sleeve is fixed between each second ring member and the sliding track by a screw fixture.

5. The horizontal fireproof rolling shutter without a lower rail of claim 4, wherein the sleeve is installed in the sliding grooves of the external frame.
